(19) United States
(12) Patent Application Publication
(10) Pub. No.: US 2004/0007330 A1
(43) Pub. Date: Jan. 15, 2004

(54) Labelling machine

(76) Inventor: William Thomas Jones, London (CA)

Correspondence Address: GOWLING LAFLEUR HENDERSON LLP, 560-120 KING STREET WEST, P.O. BOX 1045, LCD 1, HAMILTON, ON, L8N 3R4, CA

(21) Appl. No.: 10/191,064

(22) Filed: Jul. 10, 2002

(51) Int. Cl. B32B 35/00

(52) U.S. Cl. 156/541; 156/542

(57) ABSTRACT

A labelling machine for applying labels to containers has a base, and a label assembly holder carried by the base for holding a labelling assembly which has an elongated flexible carrier strip to which labels are sequentially releasably adhered. A support is carried by the base at a labelling station, and a label assembly feeder carried by the base feeds the label assembly to a location adjacent the labelling station such that the carrier strip reaches the location with the labels on a lower face thereof. The label assembly feeder has a strip reverser which causes the carrier strip to turn through a substantial angle away from the labels at the location to cause a label at the location to become detached from the carrier strip in an upside down configuration, and a label feeder feeds a detached label in the upside down configuration to an upper surface of the support. A container can be moved downwardly into contact with an upside down label at the labelling station to cause the label to adhere to the container.

### FIELD OF INVENTION

This invention relates to labelling machines.

### BACKGROUND OF INVENTION

U.S. Pat. Nos. 5,819,968; 5,934,492; 5,927,528 and 5,967,350 (Jones) relate to medication containers which are senior friendly and child resistant. In preferred embodiments described in these patents, the medication container has a cap with a central aperture and a cap liner which has a central button portion in the aperture in the cap. The cap rotates relative to the cap liner when the container is opened or closed, with such relative movement becoming apparent to a user because of relative movement between the top of the cap and the central button of the liner. By providing relevant information on the cap and/or liner, dosage information which indicates when the next dose has to be taken or when the previous dose was taken can be provided.

It is an object of the present invention to provide a labelling machine which is especially useful for applying a label to the cap and/or the central button of a medication container such as referred to above.

### SUMMARY OF INVENTION

According to one aspect of the invention, a labelling machine for applying labels to containers includes a base, a label assembly holder carried by the base for holding a labelling assembly comprising and elongated flexible carrier strip to which labels are sequentially releasably adhered, a support carried by the base at the labelling station, a label assembly feeder carried by the base for feeding the label assembly to a location adjacent the labelling station such that the carrier strip reaches the location with the labels on a lower face thereof, said label assembly feeder including a strip reverser which causes the carrier strip to turn through a substantial angle away from the labels at said location to cause a label at such location to become detached from the carrier strip in an upside down configuration, and a label feeder for feeding a detached label in the upside down configuration to an upper surface of said support, whereby a container can be moved downwardly into contact with an upside down label at the labelling station to cause the label to adhere to the container.

The labelling machine may also include a container guide adjacent to the support and engageable by the container, said container guide being movable against spring action from an upper position to a lower position, whereby the downward movement of the container causes the container to engage the container guide and move the container guide downwardly against the spring action from the upper position towards the lower position and to cause the container to contact an upside down label at the labelling station to cause the label to adhere to the container.

The container guide may be shaped to receive and guide containers with different lateral dimensions. The container guide may at least partially surround the support and be internally stepped to receive and guide containers of different lateral dimensions.

The label feed assembly may comprise a pair of drive rollers engaged in opposite sides of the carrier strip down stream of the strip reverser, and a manually operable handle operable to rotate the drive rollers to feed the label assembly through the machine.

The label feeder may have at least one tooth which feeds a detached label in the upside down configuration to an upper surface of said support, the label feeder being actuated by the manually operable handle.

According to another aspect of the invention, a method of labelling a container includes providing a label assembly comprising an elongated flexible carrier strip to which labels are sequentially releasably adhered, feeding the carrier strip with the labels attached thereto to a location adjacent a labelling station such that the carrier strip reaches the location with the labels on a lower face thereof, causing the carrier strip to turn through a substantial angle away from the labels at the location to cause a label at said location to become detached from the carrier strip in an upside down configuration, feeding a detached label in the upside down configuration to an upper face of a support at the labelling station, and moving a container downwardly into contact with an upside down label at the labelling area to cause the label to adhere to the container.

A container guide may be provided adjacent to this support, with the container guide being movable against spring action from an upper position to a lower position, with the step of moving a container downwardly also including engaging the container with the container guide and moving the container downwardly with a force sufficient to cause movement of the container guide downwardly against the spring action from the upper position towards the lower position and movement of the container into contact with an upside down label at the labelling station to cause the label to adhere to the container.

The container may include a container body and a cap secured thereto, the cap having a central aperture with a button portion of a cap liner in said aperture, each label comprising an annular portion which adheres to the cap so as to surround the aperture.

The container may include a container body and a cap with a central aperture and a button portion of a cap liner in the aperture, each label comprising a disk portion which is adhered to the button portion of the cap liner.

The container may include a container body and a cap with a central aperture and a button portion of a cap liner in the aperture, each label comprising an annular portion which adheres to the cap so as to surround the aperture and a disk portion which adheres to the button portion of the cap liner. When releasably adhered to the carrier strip, each label may also comprise and intermediate annular portion releasably connected to the disk portion and to the annular portion. Also, when releasably adhered to the carrier strip, each label may be releasably connected to an adjacent label by a bridge portion.

According to yet another aspect of the invention, a labelling assembly includes an elongated flexible carrier strip and labels sequentially and releasably adhered to the carrier strip, each label having an annular portion and a disk portion within the annular portion and releasably connected thereto. Each label may also have an intermediate annual portion between the annular portion and the disk portion and releasably connected to the annular portion and to the disk portion. Each label may also have a bridge portion releasably connected thereto and extending to an adjacent label and releasably connected thereto.

According to a still further aspect of the invention, a labelling assembly includes an elongated flexible carrier strip and labels sequentially and releasably adhered to the carrier strip, each label having a bridge portion releasably connected thereto and extending to an adjacent label and releasably connected thereto. Each label may have an annular portion with the associated bridge portion being releasably connected thereto.

### DESCRIPTION OF THE DRAWINGS

One embodiment of the present invention will now be described, by way of example, with reference to the accompanying drawings, of which:

FIG. 1 is a perspective view from above of a labelling machine in accordance with one embodiment of the invention and showing the feed handle in the rear position;

FIG. 2 is a side view of the labelling machine;

FIG. 3 is a side view similar to FIG. 2 but showing the feed handle moved to forward position;

FIG. 4 is a side view similar to FIG. 3 but showing the feed handle returned to the rear position,

FIG. 5 is a side view of the front portion of the machine showing an upside down medication container in position at the labelling area;

FIG. 6 is a side view similar to FIG. 5 but showing the medication container being pushed downwardly towards the label in the labelling area;

FIG. 7 is a side view similar to FIG. 6 but showing the medication container in the fully down position with a label adhered to the cap and button portion thereof;

FIG. 8 is a side view similar to FIG. 7 but showing the medication container with the attached label being moved upwardly;

FIGS. 9(a) (b) and (c) are perspective views of a container showing the removal of the intermediate annular portion of a label after the label has been adhered to the container cap and central button portion; and

FIG. 10 is a planned view of a portion of the label assembly.

### DESCRIPTION OF PREFERRED EMBODIMENT

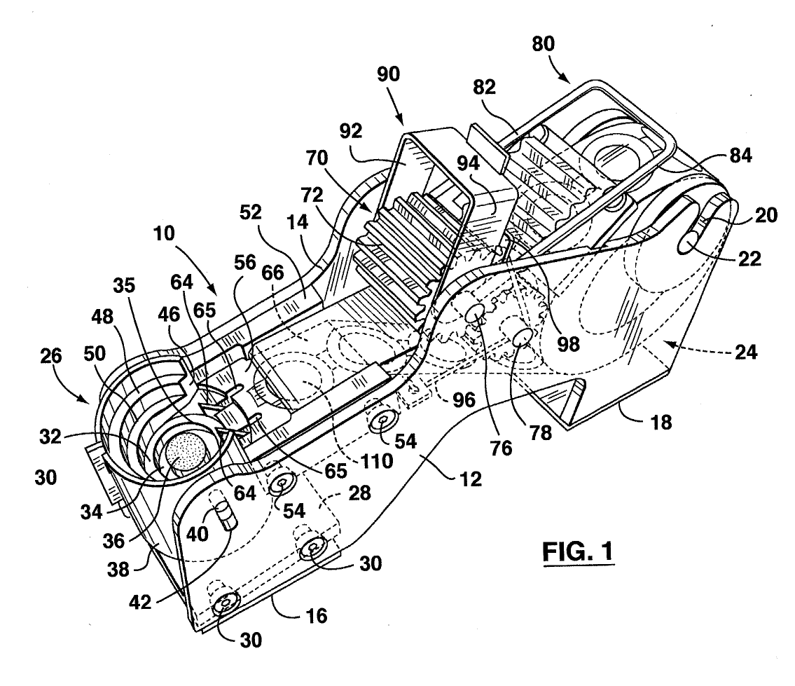

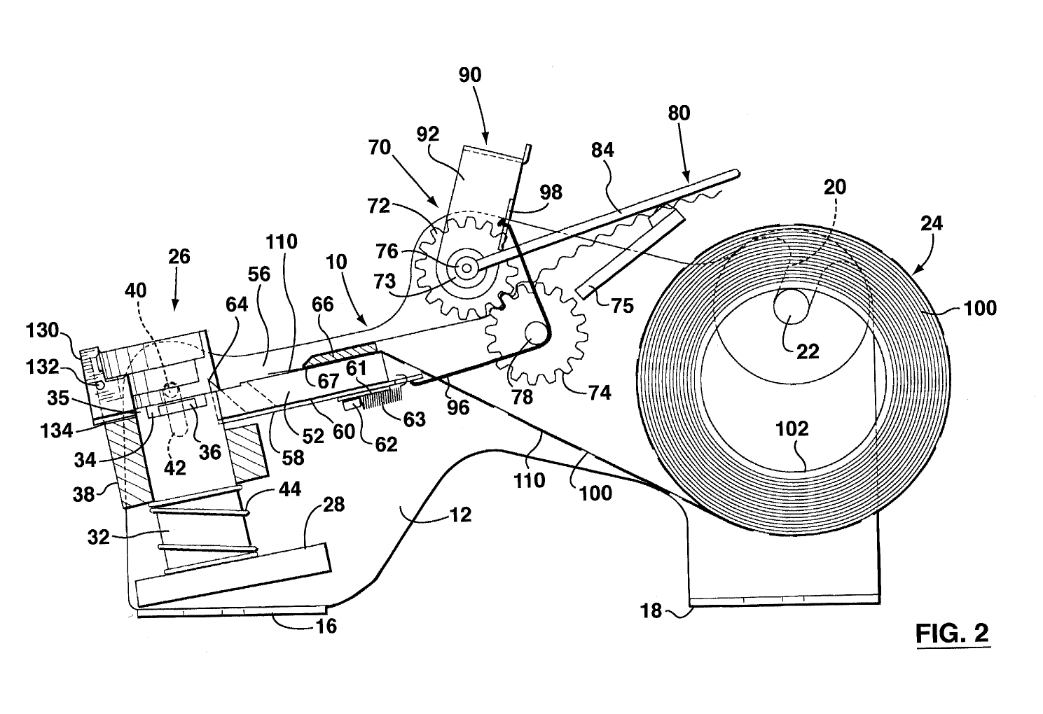

Referring first to FIGS. 1 and 2 of the drawings, a labelling machine for applying labels to a medication container has a housing 10 formed by a pair of laterally-spaced side walls 10, 12 mounted on a front base portion 16 and a rear base portion 18. The side walls 12, 14 each have a downwardly extending slot 20 in their upper edges over the rear base portion 18, and an axil 22 extends between the side walls 12, 14 with its opposite end portions sitting in the lower ends of the slots 20. A label assembly 24, which will be described in more detail later, is supported by the axil 20.

The front portion of the labelling machine provides a labelling station 26 and has a mounting plate 28 which extends between the side walls 12, 14 just above the forward base portion 16. The mounting plate 28 is inclined forwardly and downwardly and is secured to side walls 12, 14 by screws 30. A support column 32 is mounted on the mounting plate 28 and has an annular recess 34 at its upper end, with a disc-like resilient pad 36 being located in the centre thereof.

A movable cylindrical guide 38 surrounds the support column 32 and has a pair of diametrically opposite laterally outwardly projecting pins 40 which slide in slots 42, in the side walls, 12, 14. A coil spring 44 surrounding the support column 32 acts between the mounting plate 28 and the bottom of the cylindrical guide 38 to urge the guide 38 to its upper position, i.e. when the pins 40 are at the upper ends of slots 42.

The upper rear portion of the support column 34 has an opening 46 which extends approximately half way down the height thereof, and the inside of the remaining upper portion of the cylindrical guide 38 is stepped to provide annular ledges 48, 50, with ledge 50 being lower than end of smaller diameter than ledge 48.

A label feed block 52 is mounted between the side walls 12, 14 and secured thereto by screws 54 immediately to the rear of the opening 46 in the cylindrical guide 38. The top of the label feed block 52 has a longitudinally extending label feed groove 56. A label pusher 58 is slidably mounted in a grove 60 in the bottom of feed block 52, and is held in place by a holding plate 61 which extends laterally across the grooves 60 at the rear thereof and is secured to the bottom of the feeder block 52 by screws 62. The forward end of the label pusher 58 has a pair of laterally spaced teeth 64 which project upwardly into the upper groove 56 through slots 66 in the bottom of the feeder block 52. In a forward position, the teeth 64 extend into the recess 46 in the cylindrical guide 38. The teeth 64 are urged to the forward position by a tension spring 63 connected between the screws 62 and the rear of the label pusher 58. A label strip reverser 66 is mounted at the rear end of the feed groove 56 and is based slightly above the bottom thereof.

A label assembly feeder 70 is mounted in the upper middle portion of the housing and has two inter-engaging horizontal feed rollers 72, 74 having axil 76, 78 each rotatably mounted at opposite ends in respective side walls 12, 14. A U-shaped handle 80 has the free ends of its leg portions 82, 84 mounted in transverse passages (not shown) in opposite ends of axil 76 of feed roller 72. A U-shaped feed tooth actuator 90 has the free ends of its leg portions 92, 94 rotatably mounted on the outer ends of axil 76 laterally inwardly of the leg portions 82, 84 of the feed handle 80. Each leg portion 92, 94 of actuator 90 is connected by cords 96 to the rear end of label feeder 58, with medial portions of cords 96 passing around the end portions of axil 78 of feed roller 74. Each leg portion 92, 94 of actuator 90 has a wing portion 98 which is engageable by a respective leg portion 82, 84 of the feed handle 80.

The label assembly 24 includes an elongated flexible carrier strip 100 made of suitable paper and rolled on a tubular core 102 through which the axil 22 passes with the core 102 resting thereon.

Referring now to FIG. 10, labels 110 are sequentially and releasably adhered to the carrier strip 100 in a manner which will be readily apparent to a person skilled in the art. Each label 110 has a central disc portion 112 surrounded by an intermediate annular portion 114, which in turn is surrounded by a main annular portion 116. The disc portion 112 is releasably connected to the intermediate annular portion 114 which in turn is releasably connected to the main annular portion 116. Each label 110 has a bridge portion 118 releasably connected to the main annular portion 116 thereof and extending to the main annular portion 116 of the adj acent label 110 to which it is also releasably connected, as well as being releasably adhered to the carrier strip 100. The carrier strip 100 is rolled on the tubular core 102 such that the labels 110 are outermost.

To load a label assembly 24 onto the labelling machine, the axil 22 is removed from the slots 20 in the side walls 12, 14 and is passed through the tubular core 102 of the label assembly 24. The axil 22 with the label assembly 24 carried thereby is then replaced in the slots 22. The free end of the carrier strip 100 is then pulled from the underside of the label assembly 24 and passed between the bottom of the strip reverser 66 and the label feed block 52 in a rear to front direction. The carrier strip 100 is then reversibly bent at the leading end 67 of the strip reverser 66 so that the carrier strip 100 then travels rearwardly to pass between the feed roller 72, 74. The labels 110 leave the carrier strip 100 where the reverse bend occurs at the leading end 67 of the strip reverser 66. After passing between feed roller 72, 74, the carrier strip 100 passes over a strip guide 75 extending between side walls 12, 14 and secured by adhesive thereto. Portions of the carrier strip 100 which have passed over the guide 75 can be torn off and discarded.

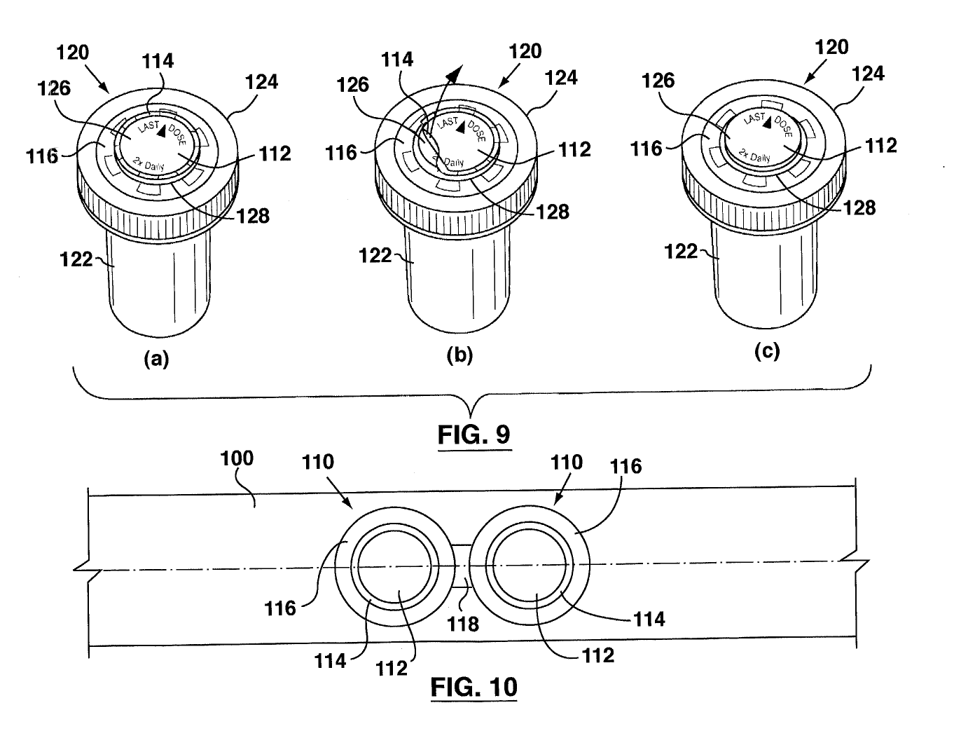

The labelling machine is used to apply labels 110 to a medication container 120 shown in FIG. 9 and described in more detail in previously mentioned U.S. Pat. No. 5,934,492.

The medication container 120 has a container body 122 with a senior friendly child resistant cap 124. The cap 124 contains a cap liner (not completely shown) which has a central button portion 126 projecting through a central aperture 128 in the cap 124.

When the container 20 is opened by removing the cap 124 from the container body 122 by anti-clockwise rotation of the cap 124 relative to the container body 120, the cap 124 moves relatively to the central button portion 126 to indicate when the container 120 is opened, again as more fully described in U.S. Pat. No. 5,934,492.

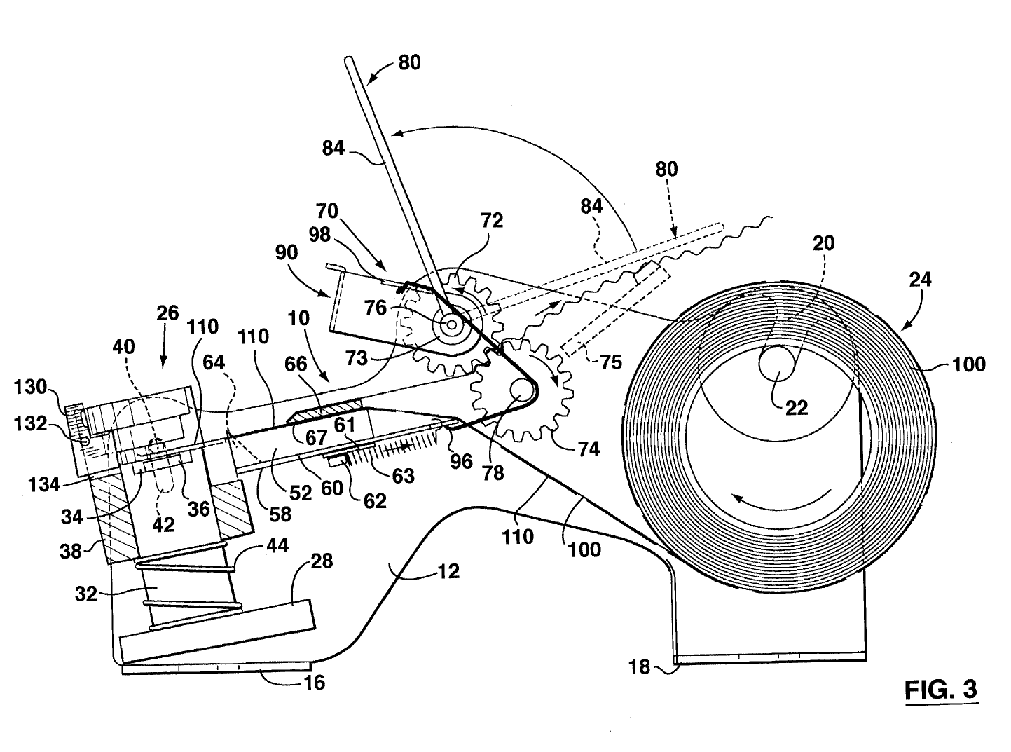

The labelling machine is used by first swinging the handle 80 in an anti-clockwise direction as shown in FIG. 3 to cause rotation of the feed roller 72, 74 and subsequent pulling of the carrier strip 100 through the machine. At the same time, because of engagement of the handle 80 with the wings 98 of the actuator 90, the anti-clockwise rotation of the handle 80 also causes similar movement of the actuator 90, thereby pulling cords 96 to pull the label pusher 58 to a rear position against the action of spring 63. During this rearward motion, the teeth 64 on the label pusher 58 become positioned behind the rear of the label 110 which is lying in an upside down configuration in the groove 56 in the label feed block 52 after having become detached from the carrier strip 100 at the leading end 67 of the strip reverser 66.

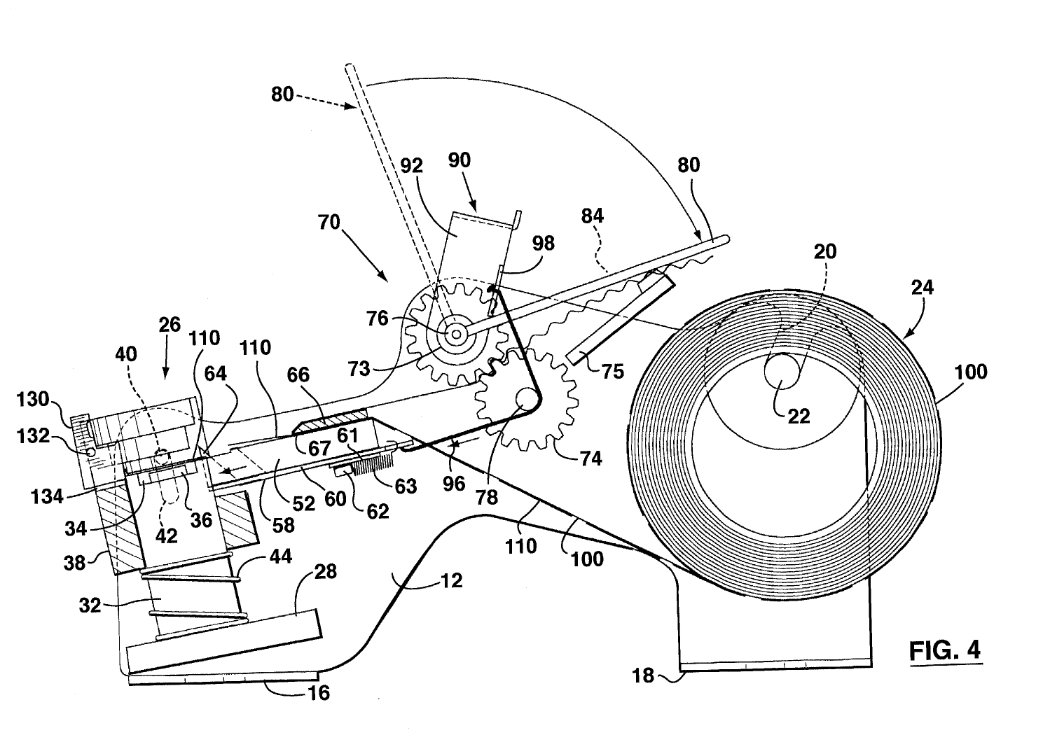

The handle 80 is then returned to its original position as shown in FIG. 4. No movement of the feed roller 72, 74 occurs because feed roller 72 contains a clutch 73 of known kind which enables handle 60 to move rearwardly without rotating the feed roller 72. Spring 63 is then able to return actuator 90 to its original position with consequent forward movement of the label pusher 58. During this movement, teeth 64 push the detached label 100 to the labelling station 26, so that the disc portion 112 of the label 110 rests on the resilient pad 36 and the main annular portion 116 of the label 110 rests on the outer annular portion 35 at the top of the support column 32.

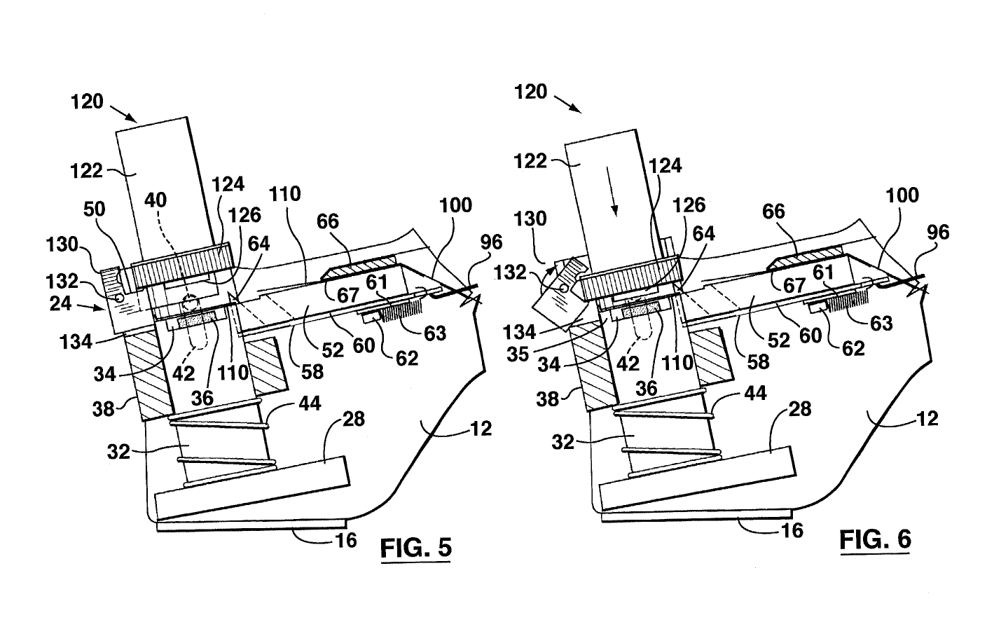

As shown in FIG. 5, an inverted mid-size container 120 is moved into the upper portion of the cylindrical guide 38, the diameter of the container cap 124 being such that it is just less than the diameter of the annular ledge 48 in the cylindrical guide 38. For this size container, the upper portion of the cylindrical guide 38 is provided with an L-shaped latch 130 pivotally mounted on a pin 32 in a slot 134 in the upper part of the cylindrical guide 38 directly opposite the opening 46. The latch 130 extends inwardly to the inner diameter of annular ledge 50. FIG. 6 shows the container 120 when it has been pushed down into engagement with the annular ledge 48. The downward movement of the cap 124 causes the latch 130 to tilt such that an upper hook-shaped portion 136 of the latch 130 engages the upper end of the container cap 124.

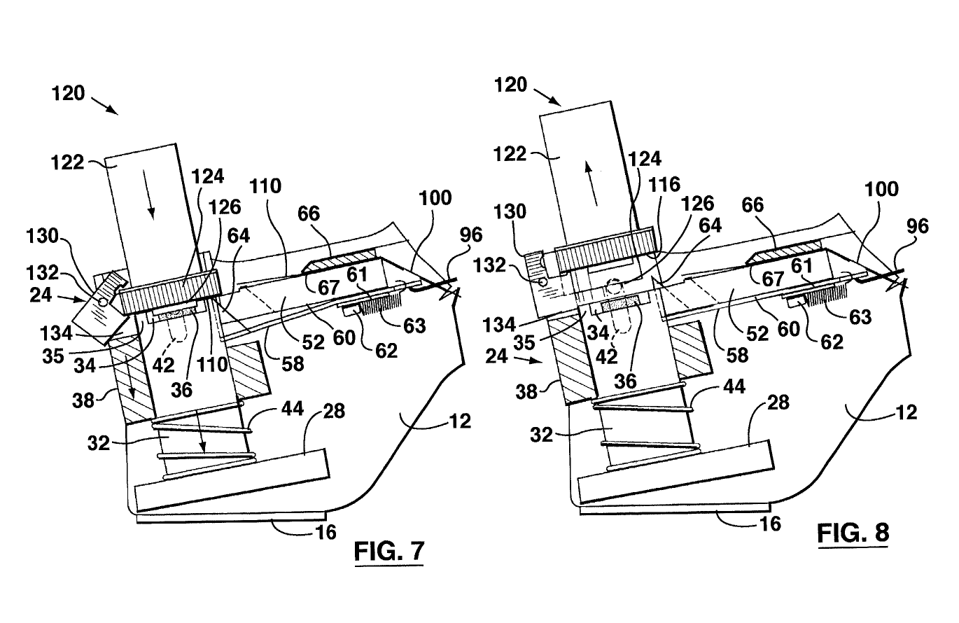

Further downward movement of the container 120, as shown in FIG. 7, causes the container 120 to push the cylindrical guide 38 downwardly against the action of the spring 44 until the cap 124 engages the outer annular portion 35 of the support column 32 (with the main annular portion 116 of the label 110 there between) and the central button portion 126 engages the resilient pad 36 (with the disc ortion 112 of the label 110 there between). The main annular portion 116 of the label 110 thereby becomes adhered to the container cap 124, and the disc portion 112 of the label 110 thereby becomes adhered to the central button portion 126. The container 120 with the label 110 attached thereto is then removed by upward movement as shown in FIG. 8. During the upward movement, the cap 124 returns the latch 130 to its original position.

FIG. 9(a) shows a container 120 just after removal from the labelling machine, with the intermediate annular portion 114 of the label 110 still adhered to the central disc portion 112. The intermediate annular portion 114 is simply removed by hand, as indicated in FIG. 9(b). The associated bridge portion 118 is also removed from the main annular portion 116 of a label 110 if it is still attached thereto. The labelled container is shown in FIG. 9(c).

If the container 120 is the larger size, then the outer annular portion of the cap 124 engages the upper annular ledge 48 of the cylindrical guide 38. If the container 120 is the smaller size, then the outer annular portion of the cap 124 engages the annular upper surface 35 of the support column 32. The cylindrical guide 38 is not depressed and the latch 130 is not actuated when the smaller container is used. Different label assemblies 24, i.e. with different labels 110, are used for different dosage information.

Other embodiments of the invention will now be readily apparent to a person skilled in the art from the above description of a preferred embodiment, the scope of the invention being defined in the appended claims.

1. A labelling machine for applying labels to containers, said labelling machine including:
a base,
a label assembly holder carried by the base for holding a labelling assembly comprising
an elongated flexible carrier strip to which labels are sequentially releasably adhered,
a support carried by the base at a labelling station,
a label assembly feeder carried by the base for feeding the label assembly to a location adjacent the labelling station such that the carrier strip reaches the location with the labels on a lower face thereof,
said label assembly feeder including a strip reverser which causes the carrier strip to turn through a substantial angle away from the labels at said location to cause a label at said location to become detached from the carrier strip in an upside down configuration, and
a label feeder for feeding a detached label in the upside down configuration to an upper surface of said support,
whereby a container can be moved downwardly into contact with an upside down label at the labelling station to cause the label to adhere to the container.

2. A labelling machine according to claim 1 also including a container guide adjacent the support and engageable by the container, said container guide being movable against spring action from an upper position to a lower position, whereby the downward movement of the container causes the container to engage the container guide and move the container guide downwardly against the spring action from the upper position towards the lower position and to cause the container to contact an upside down label at the labelling station to cause the label to adhere to the container.

3. A labelling machine according to claim 2 wherein the container guide is shaped to receive and guide the containers with different lateral dimensions.

4. A labelling machine according to claim 3 wherein the container guide at least partially surrounds the support and is internally stepped to receive and guide containers of different lateral dimensions.

5. A labelling machine according to claim 1 wherein the label feet assembly comprises a pair of drive rollers engaging opposite sides of the carrier strip downstream of the strip reverser, and a manually operable handle operable to rotate the drive rollers to feed the label assembly through the machine.

6. A labelling machine according to claim 5 wherein the label feeder has at least one tooth which feeds a detached label in the upside down configuration to an upper surface of said support, and the label feeder is actuated by the manually operable handle.

7. A method of labelling a container including:
providing a label assembly comprising an elongated flexible carrier strip to which labels are sequentially releasably adhered,
feeding the carrier strip with the labels attached thereto to a location adjacent a labelling station such that the carrier strip reaches the location with the labels on a lower face thereof,
causing the carrier strip to turn through a substantial angle away from the labels at the location to cause a label at said location to become detached from the carrier strip in an upside down configuration,
feeding a detached label in the upside down configuration to an upper face of a support at the labelling station, and
moving a container downwardly into contact with an upside down label at the labelling area to cause the label to adhere to the container.

8. A method according to claim 7 including providing a container guide adjacent the support, with the container guide being movable against spring action from an upper position to a lower position, and said step of moving a container downwardly also includes engaging the container with the container guide and moving the container downwardly with a force sufficient to cause movement of the container guide downwardly against the spring action from the upper position towards the lower position and movement of the container into contact with an upside down label at the labelling station to cause the label to adhere to the container.

9. A method according to claim 7 wherein the container includes a container body and a cap secured thereto, the cap having a central aperture with a button portion of a cap liner in said aperture, and each label comprises an annular portion which adheres to the cap so as to surround the aperture.

10. A method according to claim 7 wherein the container includes a container body and a cap with a central aperture and a button portion of a cap liner in the aperture, and each label comprises a disc portion which is adheres to the button portion of the cap liner.

11. A method according to claim 7 wherein the container includes a container body and a cap with a central aperture and a button portion of a cap lines in the aperture, and each label comprises an annular portion which adheres to the capo so as to surround the aperture and a disc portion which adheres to the button portion of the cap liner.

12. A method according to claim 11 wherein, when releasably adhered to the carrier strip, each label also comprises an intermediate annular portion releasably connected to the disc portion and to the annular portion.

13. A method according to claim 12 wherein, when releasably adhered to the carrier strip, each label is releasably connected to an adjacent label by a bridge portion.

14. A method according to claim 7 wherein, releasably adheres to the carrier strip, each label is releasably connected to an adjacent label by a bridge portion.

15. A labelling assembly including:
an elongated flexible carrier strip, and
labels sequentially and releasably adhered to the carrier strip,
each label having an annular portion and a disc portion within the annular portion and releasably connected thereto.

16. A label assembly according to claim 15 wherein each label also has an intermediate annular portion between the annular portion and the disc portion and releasably connected to the annular portion and to the disc portion.

17. A labelling assembly according to claim 16 wherein each label also has a bridge portion releasably connected thereto and extending to an adjacent label and releasably connected thereto.

18. A labelling assembly including:
an elongated flexible carrier strip and
labels sequentially and releasably adhered to the carrier strip,
each label having a bridge portion releasably connected thereto and extending to an adjacent label and releasably connected thereto.

19. A label assembly according to claim 18 wherein each label has an annular portion and the associated bridge portion is releasably connected thereto.
